(19) United States
(12) Patent Application Publication
(10) Pub. No.: US 2016/0048665 A1
(43) Pub. Date: Feb. 18, 2016

(54) UNLOCKING AN ELECTRONIC DEVICE

(71) Applicant: LENOVO ENTERPRISE SOLUTIONS (SINGAPORE) PTE. LTD., SINGAPORE (SG)

(72) Inventors: SHAREEF F. ALSHINNAWI, APEX, NC (US); GARY D. CUDAK, WAKE FOREST, NC (US); JEFFREY S. HOLLAND, DURHAM, NC (US); ROBERT B. RAINEY, MORRISVILLE, NC (US)

(21) Appl. No.: 14/457,288

(22) Filed: Aug. 12, 2014

(51) Int. Cl. G06F 21/31; G06F 3/0484; G06F 3/01

(52) U.S. Cl. CPC G06F 21/316; G06F 3/013; G06F 3/04842

(57) ABSTRACT

Unlocking an electronic device includes displaying, by a security module, a plurality of objects including at least one target object and at least one decoy object, where the at least one target object is obtained from a stored history of viewed objects, detecting, by the security module, a user selection from the plurality of objects, and in response to detecting that the user selection is one of the at least one target objects, unlocking, by the security module, the electronic device.

### BACKGROUND OF THE INVENTION

1. Field of the Invention

The field of the invention is data processing, or, more specifically, methods, apparatus, and products for unlocking an electronic device.

2. Description of Related Art

Personal computing electronics have become ubiquitous. It is not uncommon for users to carry at least one computing device, such as cell phones, tablet computers, laptop computers, digital cameras, virtual reality goggle devices, and the like. Each of these computer devices typically includes a combination of hardware and software components, application programs, operating systems, processors, buses, memory, input/output devices, and so on. As technology becomes smaller and more powerful, security of personal computing electronic devices becomes more important.

### SUMMARY

Methods, apparatus, and products for unlocking an electronic device are disclosed in this specification. Unlocking such an electronic device in accordance with embodiments of the present invention includes: displaying, by a security module, a plurality of objects including at least one target object and at least one decoy object, where the at least one target object is obtained from a stored history of viewed objects; detecting, by the security module, a user selection from the plurality of objects; and in response to detecting that the user selection is one of the at least one target objects, unlocking, by the security module, the electronic device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of an example system for unlocking an electric device according to embodiments of the present invention.

FIG. 2 sets forth a flow chart illustrating an exemplary method for unlocking an electronic device according to embodiments of the present invention.

FIG. 3 sets forth a flow chart illustrating another exemplary method for unlocking a virtual reality goggle device according to embodiments of the present invention.

FIG. 4 sets forth an example screenshot of a user interface for unlocking an electronic device according to embodiments of the invention.

### DETAILED DESCRIPTION OF EXEMPLARY EMBODIMENTS

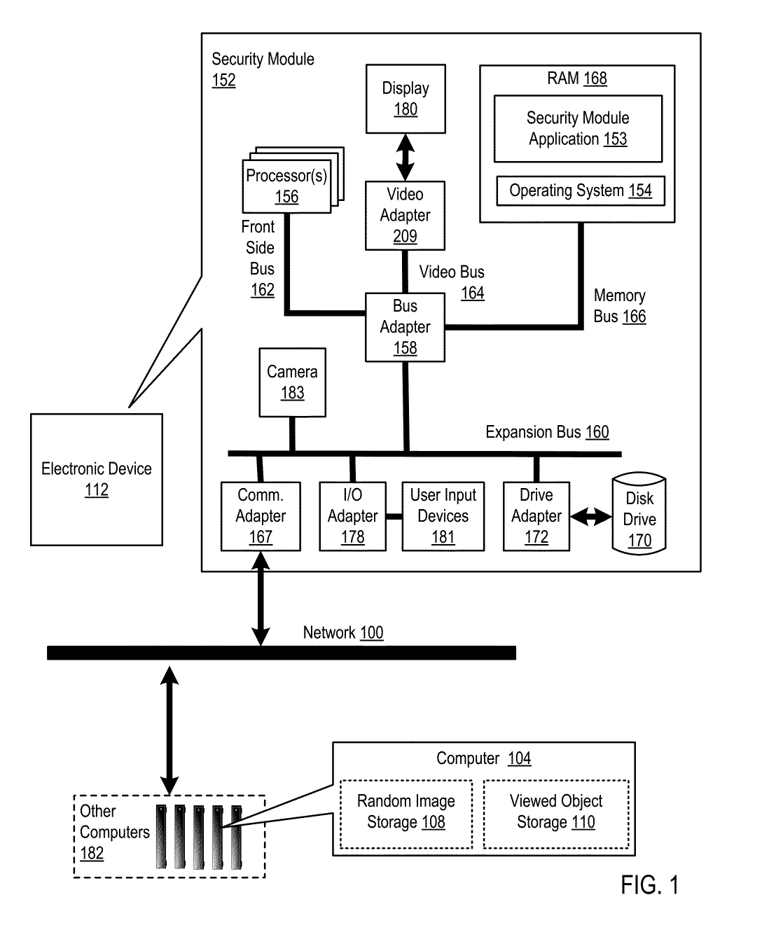

Exemplary methods, apparatus, and products for unlocking an electronic device in accordance with the present invention are described with reference to the accompanying drawings, beginning with FIG. 1. FIG. 1 sets forth a network diagram of an example system for unlocking an electric device according to embodiments of the present invention.

The example system of FIG. 1 includes automated computing machinery in the form of an electronic device (112). The electronic device (112) of FIG. 1 may be implemented in a variety of ways including, for example, as a laptop computer, tablet computer, cell phone, virtual reality goggle device, smart camera, or any other personal electronic device as will occur to readers of skill in the art. The electronic device (112) of FIG. 1 includes, among other components, a security module (152) useful for locking and unlocking an electronic device (112) according to embodiments of the present invention. The term ‘lock’ as used here refers to rendering at least a portion of features of the electronic device inoperable to a user until that user provides credentials or otherwise proves that the user is authorized to use the features rendered inoperable when the device is locked. By way of an example, many personal computers, cell phones, and other electronic devices require a user to enter a password, provide a fingerprint, or provide some other form of credentials before most of the features of the device are accessible to the user. A device may be locked when it is powered up, or may be locked manually by a user, or may be locked after a predetermined period of time that the devices is not used.

The security module (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152). Stored in RAM (168) is a security module application (153), a module of computer program instructions that, when executed, causes the security module (152) to operate for unlocking an electronic device (112) according to embodiments of the present invention. The security module application (153) may unlock an electronic device (112) according to embodiments of the present invention by displaying a plurality of objects including at least one target object and at least one decoy object, where the target object is obtained from a stored history of viewed objects (110); detecting a user selection from the plurality of objects; and in response to detecting that the user selection is one of the at least one target objects, unlocking the electronic device (112).

A ‘target object,’ as the term is used in this specification, is an image, text, or other item that a user may select to indicate that the object meets predetermined selection criteria. Conversely, a ‘decoy object,’ as the term is used in this specification, is an image, text, or other item that a user may select that does not meet the predetermined selection criteria. That is, by way of an example, the selection criteria may indicate that the user should select the object that the user recognizes. Thus, the target object may be an image captured by a camera of the electronic device, whereas the decoy object is a random image. In addition, the selection criteria may be more complex. As an example, the selection criteria may indicate that the user should select an object that was viewed one month ago. Thus, the objects may all be images captured by a camera of the electronic device, but the user will be able to recognize which one was viewed by the user one month ago. In this example, the decoy object may be recognizable to the user, but the user will recognize that the decoy object does not meet the selection criteria.

Also stored in RAM (168) is an operating system (154). Operating systems useful in security modules configured for unlocking an electronic device according to embodiments of the present invention include UNIX™, Linux™, Microsoft Windows™, OS X™, Chromium OS™, AIX™, IBM's i5/OS™, and others as will occur to those of skill in the art. The operating system (154) and security module application (153) in the example of FIG. 1 are shown in RAM (168), but many components of such software typically are stored in non-volatile memory also, for example, on a disk drive (170).

The security module (152) of FIG. 1 includes disk drive adapter (172) coupled through expansion bus (160) and bus adapter (158) to processor (156) and other components of the management module (152). Disk drive adapter (172) connects non-volatile data storage to the management module (152) in the form of disk drive (170). Disk drive adapters useful in security modules configured for unlocking an electronic device according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

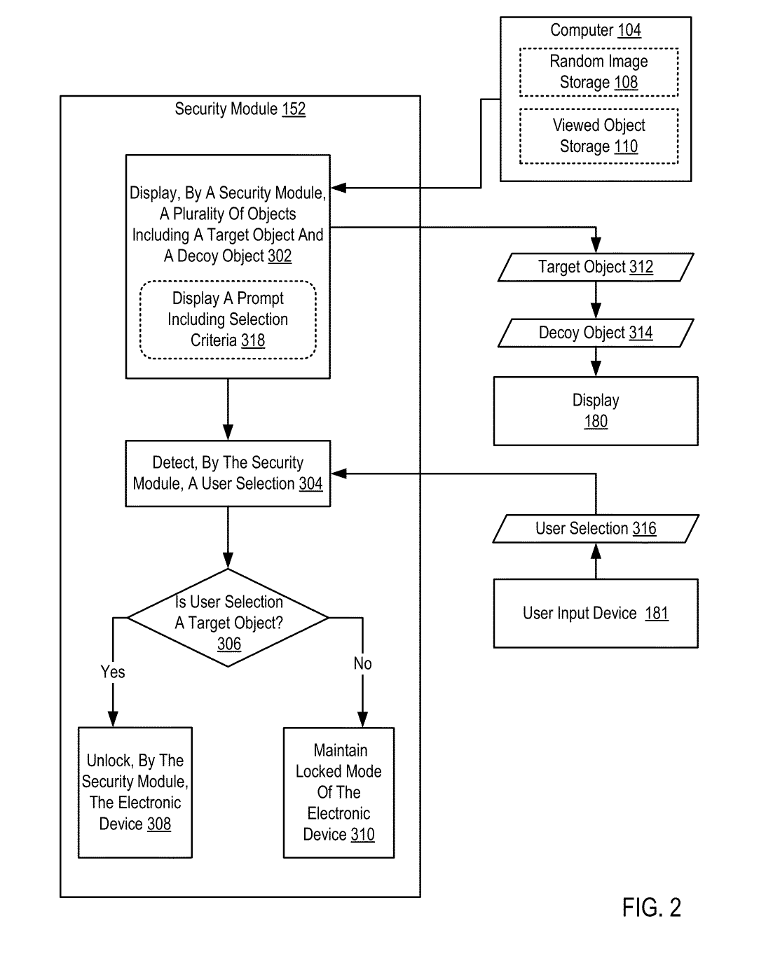

The example security module (152) of FIG. 2 includes one or more input/output (‘I/O’) adapters (178). I/O adapters implement user-oriented input/output through, for example, software drivers and computer hardware for controlling output to display devices (180) such as computer display screens, as well as user input from user input devices (181) such as keyboards and mice. In one or more embodiments, user input devices (181) may include other devices, such as a touch screen, or an eye tracking device, as well as other input devices as will be apparent to those skilled in the art. The example management module (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary security module (152) of FIG. 1 also includes a camera (182) connected through expansion bus (160), which captures real world images. In one or more embodiments, the images captured by the camera (182) are stored to viewed object storage (110).

The exemplary security module (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in security modules configured for unlocking an electronic device according to embodiments of the present invention include modems for wired dial-up communications, Ethernet (IEEE 802.3) adapters for wired data communications, and 802.11 adapters for wireless data communications.

The example security module (152) of FIG. 1 may communicate with other computers (182) across the network (100). One computer (104) of the other computers (182) in the example of FIG. 1 may be configured with random image storage (108) and viewed object storage (110). In one or more embodiments, the data depicted as stored in computer (104) may alternatively, or additionally, be stored in another storage across network (100), such as disk drive (170). In one or more embodiments, the example security module (152) selects a target object from viewed object storage (110) of the computer (104) via network communications. Objects stored in viewed objects storage (110) include objects which have been viewed by a user of electronic device (112). For example, electronic device (112) may include a camera (183) that captures real world images and images captured by the user are stored in viewed object storage (110) of the computer. In one or more embodiments, security module (152) selects a decoy object from the random image storage (108) of the computer (104) via network communications. In one or more embodiments, the random image storage (108) includes objects that have not been viewed by the user.

The arrangement of networks, electronic devices and other computers making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art.

Various embodiments of the present invention may be implemented on a variety of hardware platforms in addition to those illustrated in FIG. 1.

For further explanation, FIG. 2 sets forth a flow chart illustrating an exemplary method for unlocking an electronic device according to embodiments of the present invention. The electronic device may be locked, for example, after a period of inactivity by a user, or immediately after startup of the electronic device so as to restrict operational access from unauthorized users. The method of FIG. 2 may be carried out by a security module, or a security application, similar to that depicted in FIG. 1.

The method of FIG. 2 includes displaying (302), by a security module (152), a plurality of objects including a least one target object (312) and at least one decoy object (314). Displaying (302), by a security module (152), a plurality of objects including at least one target object (312) and at least one decoy object (314) may be carried out by selecting images of the target object and decoy object from storage and rendering the selected images of the objects on a display (180). In one or more embodiments, the target object is obtained from a stored history of viewed objects (110). Thus, the target object is an image of an object that the user has viewed and will likely be familiar to the user. In addition, security module (152) retrieves one or more decoy objects from random image storage (108).

The target object and the decoy object are displayed on display (180). In one or more embodiments, display (180) may be a display on the electronic device to be unlocked such as a screen of a mobile computing device. In one or more embodiments, the objects are displayed on a display device of another computer or electronic device. For example, in some embodiments, the electronic device (112) may be a virtual reality goggle device. In such an embodiment, the viewed object storage (110) may include objects that have been viewed by the virtual reality goggle device. That is, in embodiments of the invention, the viewed object storage (110) includes stored images that have been viewed by the user through or with the electronic device. For example, the viewed objects may be images captured by a camera included in the mobile communications device.

In some embodiments, the random image storage (108) includes random images that may be confused for real world images stored in viewed object storage (110). That is, by way of an example, if the selection criteria indicates that the user should select an image that the user recognizes because the image was captured by a camera of the electronic device, then random image storage (108) includes images that could be confused for images captured by the camera. In one or more embodiments, the random image storage includes a database of stock photographs.

In one or more embodiments, displaying a decoy object includes selecting an object from a random image storage (108), determining that the object is not also stored in viewed object storage (110), and displaying the selected object as the target object. Alternatively, displaying a decoy target object includes selecting an object from random image storage (108) or viewed object storage (110), determining that the object does not match the selection criteria, and displaying the selected object as the decoy object (314). Selection criteria, as the term is used here, may refer to characteristics that identify a target object using user knowledge.

In one or more embodiments, displaying (302), by a security module (152), a plurality of objects including a target object (312) and a decoy object (314) may also include displaying (318) a prompt including the selection criteria. In one or more embodiments, displaying selection criteria may include, for example, prompting the user to select an image that the user has seen before. Thus, security module (152) will display at least one image captured by, for example, a camera in the electronic device as the target object, and at least one object that the user should not recognize, as the decoy object. As another example, the selection criteria (318) may prompt the user to select an object based on personal knowledge that allows the user to differentiate one target objects among the target object and the decoy object. For example, the prompt may request the user select, from the target and decoy objects, the object viewed one month ago. In such an example, the decoy object may include an image that the user may recognize, but the user will know was not viewed one month ago. To that end, the decoy object is not selected from random image storage (108), but is instead also selected from viewed object storage (110).

The method also includes detecting (304), by the security module, a user selection (316) from the plurality of objects. In one or more embodiment, a user selection may be received via a user input device (181) such as a retina detection device, a keyboard, a mouse, a microphone or other input device. In one or more embodiments, the user selection is detected, for example, when a user gazes at the object with the user's eyes, or selects the object by touching the object using a touch screen, or otherwise submits user input via user input device (181).

The method also includes determining (306) whether the user selection (316) is the target object, or one of the target objects. In one or more embodiments, determining whether the user selection is the target object, or one of the target objects, includes determining whether the selected object meets the selection criteria. If the user selection (316) is a target object (312), the method includes unlocking (308), by the security module, the electronic device (112). If the user selection (316) is not a target object (that is, if the user selection is a decoy object), then the method includes maintaining (310) a locked mode of the electronic device (112).

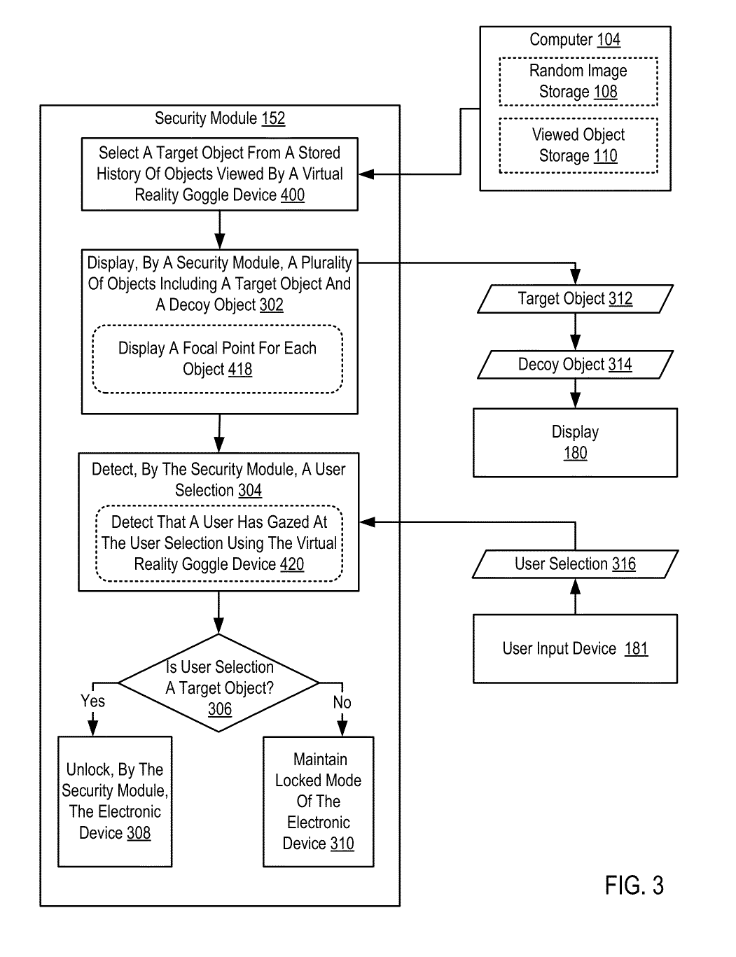

For further explanation, FIG. 3 sets forth a flow chart illustrating an exemplary method for unlocking an electronic device, where the electronic device is a virtual reality goggle device, according to embodiments of the present invention. The method of FIG. 3 may be carried out in a security module similar to that of FIG. 1. The method of FIG. 3 is similar to the method of FIG. 2 in that the method of FIG. 3 includes displaying (302), by a security module, a plurality of objects including a target object and a decoy object, detecting (304), by the security module, a user selection, and determining (306) whether the user selection is a target object, if the user selection is a target object, unlocking (308), by the security module, the electronic device, and if the user selection is not a target object, maintaining (310) locked mode of the electronic device.

The method of FIG. 3 differs from the method of FIG. 2, however, in that prior to displaying (302), by a security module, a plurality of objects including a target object and a decoy object the method of FIG. 3 includes selecting (400) a target object from a stored history of objects viewed by a virtual reality goggle device. Selecting the target object may include selecting the target object based on frequency of viewing the object, length of time the object is viewed, or how recent the object was viewed. That is, the target object may be selected such that there is a high likelihood the object will be recognized by the user as having been seen before. In one or more embodiments, the target object may be selected based on the context in which the image was generated, or may have been viewed on a device communicably connected to the electronic device. For example, if the electronic device (112) is a virtual reality goggle device, the target object may be selected from one of the other computers (182) across a network, such as a connected smart phone. That is, the virtual reality goggle device may select a picture taken using the smart phone as the target object. As another example, the target object may be selected from other content, such as text messages or social media posts. In one or more embodiments, stored history of objects viewed by the virtual reality goggle device includes images that the user has viewed using the virtual reality goggle device. For example, the target object may be selected from stored images that have been captured using a camera of the virtual reality goggle device. Thus, in one or more embodiments, the target object is selected such that the user has real world knowledge of the target object.

The method of FIG. 3 also differs from that of FIG. 2 in that displaying (302), by a security module, a plurality of objects including a target object and a decoy object optionally includes displaying (418) a focal point for each object of the plurality of objects. In one or more embodiments, the user interacts with the focal point in order to select the corresponding object as the user selection (316). The focal point may be overlaid on the display of the object, or may be displayed separate from the corresponding object. For example, the focal point may be an area above, below, adjacent, and the like in relation to the corresponding object. In one or more embodiments, providing a focal point for each object that is separate from the corresponding object helps avoid false positives where a user gazes at an unknown image in order to comprehend the image rather than select the image.

In one or more embodiments, the method also differs in that detecting (304), by the security module, a user selection may optionally include detecting (420) that a user has gazed at the user selection using the virtual reality goggle device. That is, in one or more embodiments, the electronic device (112) may include an eye tracking device as part of the user input devices (181) that tracks eye movement of the user. The user selection may be detected when the user gazes at, for example, the selected object or the focal point for the selected object. The length of time the user must on the target area in order to make a selection may be a customizable setting.

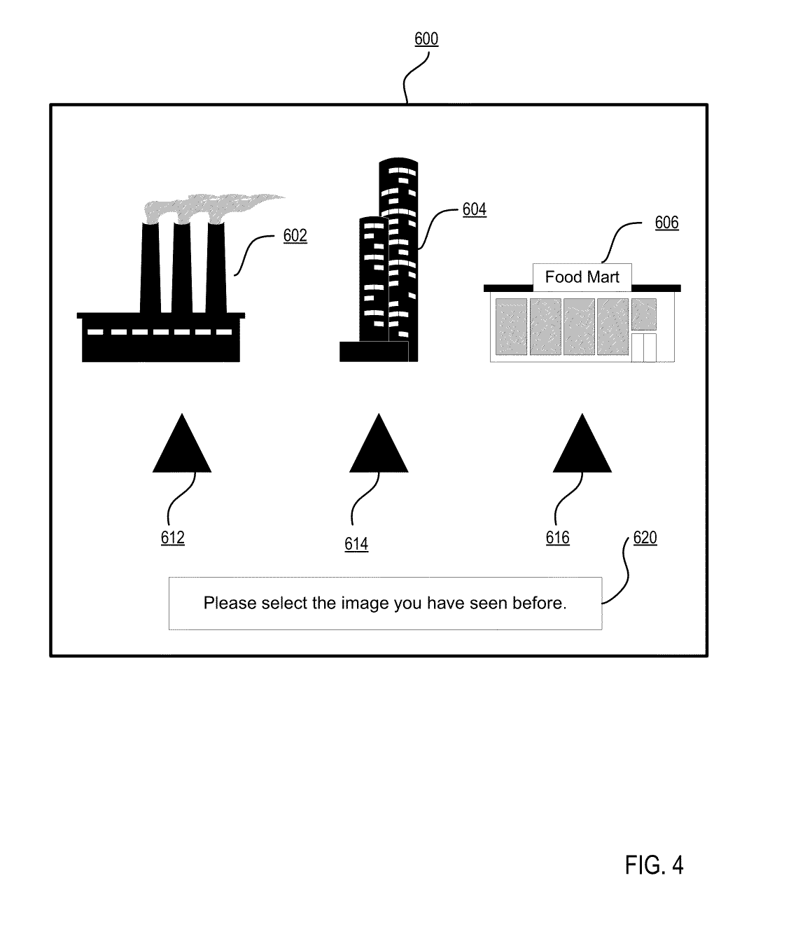

For further explanation, FIG. 4 sets forth an example screenshot of a user interface for unlocking an electronic device according to embodiments of the invention. FIG. 4 includes an example display (600) according to one or more embodiments of the present invention. It is to be understood that the diagram depicted in FIG. 4 is merely an example of any number of embodiments of the invention. The example display (600) of FIG. 4 may be viewed by a user on a display device, such as display device (180). The example display (600) includes objects (602, 604, 606). That is, a security module has displayed the objects. The objects include at least one target object and at least one decoy object. For purposes of this example, it is to be understood that object (604) is the target object.

The example display (600) also includes a prompt (620) that provides the user with selection criteria useful for determining the target object. As depicted in the display (600), the prompt (620) instructs the user to “Please select the image you have seen before.” That is, the target object (604) is retrieved, for example, from a viewed object storage, and the criteria for the target object is that it is an object the user has seen in the real world. For example, the target object (604) may be an image that a user captured with a camera of the electronic device, or otherwise viewed through the electronic device and, thus, it can be determined that the user would recognize the image.

The example display (600) also includes several focal points (612, 614, 616). In the example presented, focal point (612) corresponds to object (602), focal point (614) corresponds to object (604), and focal point (616) corresponds to object (606). The focal points (612, 614, 616) provide a selection area on the display that, as depicted, may be displayed separate from each of the objects. A user interaction with the focal point allows the user to select the corresponding object. For example, a user may gaze at or touch on a touch screen at focal point (612) to select object (612).

As discussed above, for purposes of this example, object (604) is the target object, and objects (602) and (606) are decoy objects. Thus, if a user selects object (604), then the security module will unlock the electronic device. That is, if the security module detects that the user selection is the target object, then the security module unlocks the electronic device. However, if a user selects either object (602) or object (606), the electronic device will remain locked.

In view of the explanations set forth above, readers will recognize that the benefits of unlocking an electronic device according to embodiments of the present invention include a potentially hands-free method of unlocking an electronic device. In addition, the benefits also include using a user's real world knowledge of activity using the electronic device to unlock the device.

Exemplary embodiments of the present invention are described largely in the context of a fully functional computer system for unlocking an electronic device. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of unlocking an electronic device, the method comprising:
displaying, by a security module, a plurality of objects comprising at least one target object and at least one decoy object, wherein the at least one target object is obtained from a stored history of viewed objects;
detecting, by the security module, a user selection from the plurality of objects; and
in response to detecting that the user selection is one of the at least one target objects, unlocking, by the security module, the electronic device.

2. The method of claim 1, wherein the electronic device is a virtual reality goggle device and the method further comprises selecting, by the security module, the at least one target object from a stored history of objects viewed by the virtual reality goggle device.

3. The method of claim 2, wherein detecting the user selection comprises detecting that a user has gazed at the user selection using the virtual reality goggle device.

4. The method of claim 1, wherein the electronic device comprises a camera and the method further comprises selecting, by the security module, the at least one target object from stored images captured by the camera.

5. The method of claim 1, wherein displaying the plurality of objects further comprises displaying a prompt to a user of a selection criteria, wherein the target object satisfies the selection criteria, and the at least one decoy object does not satisfy the selection criteria.

6. The method of claim 3, wherein displaying the plurality of objects comprises providing, by the security module, a focal point for each of the plurality of objects that is displayed separate from each of the plurality of objects, and a user's gaze at the focal point indicates the user selection.

7. An apparatus for unlocking an electronic device, the apparatus comprising a computer processor, a computer memory operatively coupled to the computer processor, the computer memory having disposed within it computer program instructions that, when executed by the computer processor, cause the apparatus to carry out the steps of:
displaying, by a security module, a plurality of objects comprising at least one target object and at least one decoy object, wherein the at least one target object is obtained from a stored history of viewed objects;
detecting, by the security module, a user selection from the plurality of objects; and
in response to detecting that the user selection is one of the at least one target objects, unlocking, by the security module, the electronic device.

8. The apparatus of claim 7, wherein the electronic device is a virtual reality goggle device and the method further comprises selecting, by the security module, the at least one target object from a stored history of objects viewed by the virtual reality goggle device.

9. The apparatus of claim 8, wherein detecting the user selection comprises detecting that a user has gazed at the user selection using the virtual reality goggle device.

10. The apparatus of claim 7, wherein the electronic device comprises a camera and the method further comprises selecting, by the security module, the at least one target object from stored images captured by the camera.

11. The apparatus of claim 7, wherein displaying the plurality of objects further comprises displaying a prompt to a user of a selection criteria, wherein the target object satisfies the selection criteria, and the at least one decoy object does not satisfy the selection criteria.

12. The apparatus of claim 9, wherein displaying the plurality of objects comprises providing, by the security module, a focal point for each of the plurality of objects that is displayed separate from each of the plurality of objects, and a user's gaze at the focal point indicates the user selection.

13. A computer program product for unlocking a virtual reality goggle device, the computer program product disposed upon a computer readable medium, the computer program product comprising computer program instructions that, when executed, cause a computer to carry out the steps of:
displaying, by a security module, a plurality of objects comprising at least one target object and at least one decoy object, wherein the at least one target object is obtained from a stored history of viewed objects;
detecting, by the security module, a user selection from the plurality of objects; and
in response to detecting that the user selection is one of the at least one target objects, unlocking, by the security module, the electronic device.

14. The computer program product of claim 13, wherein the electronic device is a virtual reality goggle device and the method further comprises selecting, by the security module, the at least one target object from a stored history of objects viewed by the virtual reality goggle device.

15. The computer program product of claim 14, wherein detecting the user selection comprises detecting that a user has gazed at the user selection using the virtual reality goggle device.

16. The computer program product of claim 13, wherein the electronic device comprises a camera and the method further comprises selecting, by the security module, the at least one target object from stored images captured by the camera.

17. The computer program product of claim 13, wherein displaying the plurality of objects further comprises displaying a prompt to a user of a selection criteria, wherein the target object satisfies the selection criteria, and the at least one decoy object does not satisfy the selection criteria.

18. The computer program product of claim 15, wherein displaying the plurality of objects comprises providing, by the security module, a focal point for each of the plurality of objects that is displayed separate from each of the plurality of objects, and a user's gaze at the focal point indicates the user selection.

19. The computer program product of claim 13 wherein the computer readable medium comprises a signal medium.

20. The computer program product of claim 13 wherein the computer readable medium comprises a storage medium.
